(19) United States
(12) Patent Application Publication
(10) Pub. No.: US 2004/0170843 A1
(43) Pub. Date: Sep. 2, 2004

(54) Poly(vinyl alcohol) coated capillaries

(76) Inventors: Tohei Moritani, Coram, NY (US); Benjamin Chu, Setauket, NY (US)

Correspondence Address: Tohei Moritani, 144 Pointe Circle North, Coram, NY, 11727, US

(21) Appl. No.: 10/375,328

(22) Filed: Feb. 27, 2003

(51) Int. Cl. B32B 25/20

(52) U.S. Cl. 428/429

(57) ABSTRACT

Coated fused silica capillaries useful for capillary electrophoresis are disclosed. The coating materials used are the copolymer comprising comonomer units represented by the formulae:

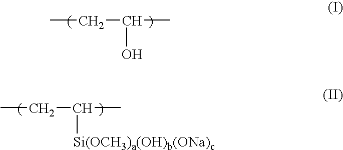

whrein a, b and c are molar fractions having the values from 0 to 100 mol %. This coating improves stability and resolution dramatically in the analytical separation of capillary electrophoresis for ionic molecules such as DNA, proteins or small molecules. The new coating capillaries are much more advantageous in reliability and facility than the similar prior arts of coated capillaries where the three sensitive reaction steps, covalently bonding monomer group, polymerization and hydrolysis, are carried out inside capillaries.

### RELATED APPLICATIONS

Not Applicable

### STATEMENT REGARDING FEDERALLY SPONSORED RESEARCH OR DEVELOPMENT

The invention was made with support provided by the National Human Genome Research Institute (2R01 HG01386-07) and the National Science Foundation MRSEC for Polymers at Engineered Surfaces; therefore, the government has certain rights in the invention.

### BACGROUND OF THE INVENTION

1. Field of the Invention

The present invention relates to capillaries, made of silica or glass in particular, having inner surface coatings which are helpful for analytical uses such as electrophoretic separation methods in particular. More particularly, the present invention involves silica or glass capillaries having a neutral hydrophilic coating on their inner wall surfaces that are effective for analytical quality and stability presumably due to the reduction of the interaction between sample ions in water and surface walls. More particularly, the present invention provides an effective and convenient method for inner surface coatings of silica capillaries. Inner capillary coating with polymers is critical in capillary electrophoresis because many polymer separation media are incompatible with the capillary wall surface. FIG. 1-a illustrates electrophoresis using a fused silica capillary where ionized silanol groups on a silica surface make an electric layer, which can exert significant influence on electrophoresis. It generates the flow of counter ions known as electroosmotic flow (EOF). Further remarkable and undesirable effects are ionic interactions or adsorption of sample ions, DNA for example, to the wall surface. Polymer coated on the inner wall of a capillary, as shown in FIG. 1-b, blocks the silanol groups on the walls and prevents the undesirable effects of adsorption and EOF. Thus, stable and reproducible electrophoretic separation analysis can be carried out. Medium polymer shown in the figure is used for sieving sample molecules.

2. Description of Relevant Art

In order to block the silanol group and to improve the properties of surfaces, various inner capillary coating methods, dynamic or permanent, have been investigated. Poly(acrylamide), poly(ethylene glycol), poly(ethyleneimine), poly(vinyl pyrrolidone) and epoxy resins have been proposed according to A. M. Dougherty, N. Cook and P. Shieh [In: Landers, J. P. (Ed), Handbook of Capillary Electrophoresis, CRC Press, Boca Raton, Fla., 1997, pp 675-715, “Capillary surface modification in capillary electrophoresis”]. Poly(vinyl alcohol) (PVAL) has also been known in the literature and commercially used as a coating material for capillaries. M. Gilges, M. H. Kleemiss, and G. Schomburg [Anal. Chem. 66 2038 (1994), “Capillary zone electrophoresis separations of basic and acidic proteins using poly(vinyl alcohol) coatings in fused silica capillaries”] have used PVAL in the “dynamic” mode as an additive to media as well as in the “permanent” mode by thermal immobilization. C—H. Shieh [USP-5605613 (1997), “Polyvinylalcohol coated capillary electrophoresis columns”] has carried out coatings by in-capillary polymerization of vinyl acetate followed by hydrolysis using the capillaries treated with polybutadiene modified with the silanol group. B. L. Karger and W. Goetzinger [USP-5840388 (1998), “Polyvinyl alcohol (PVA) based covalently bonded stable hydrophilic coating for capillary electrophoresis”] have also shown another in-capillary polymerization method using the capillaries treated with vinyltrimethoxysilane.

Dynamic coating such as the method shown by Gilges et al. is based on the physical interaction between coating materials dissolved in a medium and inner capillary walls, and therefore coating procedure is comparatively easy or convenient. The coating, however, is sometimes unstable because of the weak strength to the walls. On the other hand, permanent coatings shown by Shieh and Karger et al. are more reliable because chemically covalent bonding is formed between coating materials and inner capillary walls. The procedure including in-capillary polymerization and in-capillary hydrolysis, however, is troublesome and sometimes easy to make defects due to the inhibition effects in polymerization inside a capillary. Additionally, it is difficult to control polymerization and hydrolysis in capillary.

The present novel invention using poly(vinyl alcohol) modified with silanol group (PVAL-Si) as a coating material, instead, provides a reliable chemically-linked covalent bonding between the coating material and inner capillary walls by the easy and convenient method of the treatment of an aqueous solution of PVAL-Si. In this sense, This invention provides both the advantages of dynamic and permanent coating methods.

In FIG. 2, the direct treatment method of PVAL-Si in this work (a) is compared with the current coating method using the three reaction steps inside a capillary, covalently bonding monomer group, polymerization and hydrolysis (b). The latter is the process of grafting ‘from’ a silica surface and includes three reaction steps all in a capillary: introducing covalently bonding monomer group, polymerization and hydrolysis. On the other hand, the former, the present invention, is just the process of treatment of an aqueous solution of PVAL-Si in capillaries. The PVAL-Si molecules are adsorbed by the wall of surface and react with the silanol groups on the walls. Both methods are believed to result in almost the same chemical structure. Obviously the direct treatment of PVAL-Si or the method of ‘grafting onto’ is significantly simpler and more convenient than the method of ‘grafting from’. In the present invention, the sensitive polymerization reactions are all carried out outside a capillary.

Technology on PVAL modified with vinyltrimethoxysilane (PVAL-Si) has been known: R. Buning, Angew. Makromol. Chem., 1979, 81, 137-145; H. Maruyama, T. Moritani, T. Akazawa, T. Sato, Br. Polym. J. 1988, 20, 345-351. However, the application of PVAL-Si to inner capillary coating has never been known.

### SUMMARY OF THE INVENTION

The present invention provides an effective coated capillaries for the application to electrophoretic separation analysis, wherein coating is carried out using the copolymer comprising comonomer units respectively represented by the formulae:

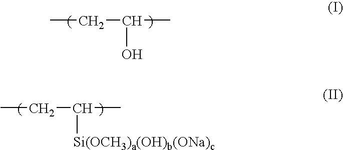

whrein R is a lower alkyl group, B is an alkali metal, and a, b and c are molar fractions having the values from 0 to 100 mol %. Typical copolymers used as coating materials are the hydrolyzed products of poly(vinyl ester-co-vinyltrialkoxysilane). The hydrolyzed products can be called poly(vinyl alcohol) modified with silanol group or PVAL-Si for abbreviation.

In another embodiment, the present invention provides the efficient method of coating capillaries by treatment of an acidic aqueous solution of the said PVAL-Si or by grafting onto a capillary.

In another embodiment, the present invention provides the superior quality of electrophoretic analysis, resolution, stability, reproducibility etc.

In another embodiment, the present invention provides effective elimination of electroosmotic flow by the chemical reaction between the said PVAL-Si and wall surface of capillaries.

### BRIEF DESCRIPTION OF THE FIGURES

FIG. 1 shows a schematic representation of capillary electrophoresis for DNA separation analysis. a. Electroosmotic flow (EOF) and adsorption of DNA induced by ionized silanol group on a silica surface. b. Capillary electrophoresis using poly(vinyl alcohol) as a coating material.

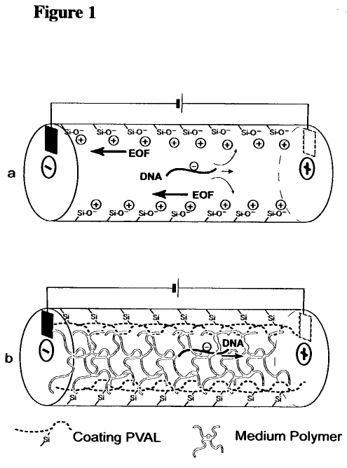

FIG. 2 shows a schematic representation of a comparison of the two methods of inner capillary coating with poly(vinyl alcohol), the direct treatment of PVAL-Si shown in the present invention (a), and the current method based on the three reaction steps inside a capillary, covalently bonding monomer group, polymerization and hydrolysis (b).

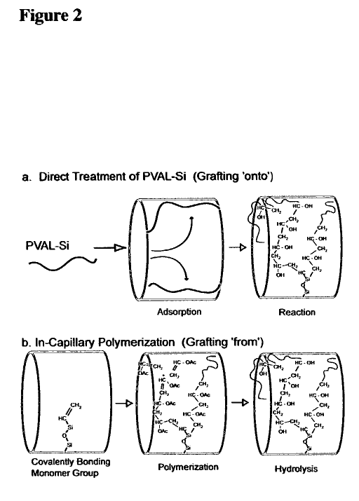

FIG. 3 provides chemical schemes showing the method for the synthesis of the PVAL-Si as well as the grafting method onto a silica capillary.

FIG. 4 shows the observed electroosmotic flow (EOF) mobilities for the four kinds of capillaries under the three conditions of pH.

FIG. 5 shows an electrophoregram of DNA restriction fragments in a capillary coated with PVAL-Si (DH=100 mol %) containing 0.2 mol % of silanol group, the capillary of this invention, and using PVA (DS=2800, DH=88 mol %, concentration=5 wt %) as a medium.

FIG. 6 shows a control experiment for comparison, an electrophoregram of DNA restriction fragments in a capillary coated with non-modified PVAL, and using PVA (DS=2800, DH=88 mol %, concentration=5 wt %) as a medium.

FIG. 7 shows an electrophoregram of DNA restriction fragments in a capillary coated with PVAL-Si (DH=100 mol %) containing 0.05 mol % of silanol group, the capillary of this invention, and using PVA (DS=2800, DH=88 mol %, concentration=5 wt %) as a medium.

FIG. 8 shows an electrophoregram of DNA restriction fragments in a capillary coated with PVAL-Si (DH=88 mol %) containing 0.2 mol % of silanol group, the capillary of this invention, and using PVA (DS=2800, DH=88 mol %, concentration=5 wt %) as a medium.

FIG. 9 shows an electrophoregram of DNA restriction fragments in a capillary coated with PVAL-Si (DH=100 mol %) containing 0.2 mol % of silanol group, the capillary of this invention, and using poly(acrylamide) (MW=9000, concentration=4 wt %) as a medium.

### DETAILED DESCRIPTION OF THE INVENTION

This invention relates to new coated capillaries useful for elctrophoretic separation analysis of ionic substances such as DNA, other polynucleotides, proteins, nucleic acids, drugs and other ionic molecules.

The coated capillaries of this invention contribute to eliminating adsorption effects between solutes for analysis and walls, and eliminating electroosmotic flow caused by the ionized silanol group on the silica walls. As the results, the coated capillaries of this invention contribute to improvement of the quality, stability and reproducibility of the electrophoretic analysis.

The coating material of this invention is the copolymer comprising comonomer units represented by the formulae:

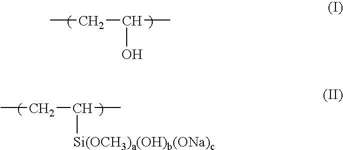

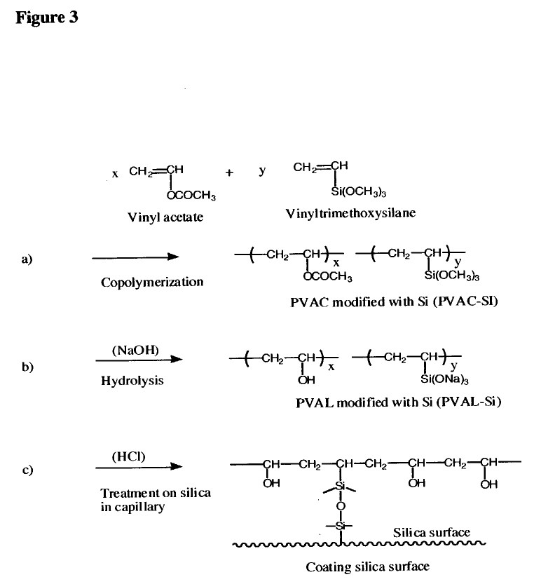

whrein R is a lower alkyl group, B is an alkali metal, and a, b and c are molar fractions having the values from 0 to 100 mol %. This copolymer can be obtained by the hydrolysis of the product from copolymerization of vinyl ester, vinytrialkoxysilane and other comonomers. The vinyl ester usable in producing the copolymers of this invention are, for example, vinyl acetate, vinyl propionate and vinyl foarmate. Vinyl acetate is preferred from the standpoint of economics. The vinyltrialkoxysilane usable in producing the copolymers of this invention are, for example, vinyltrimethoxysilane, vinyltriethoxysilane and vinyltripropoxysilane. The other comonomers in producing of this invention are not usually necessary but can be used for modification. Such comonomer usable are ethylene, propylene, vinyl chloride, alkyl acrylate, alkyl methacrylate, N-vinylpyrrolidone and other polymerizable vinyl compoundes. The copolymerization of the vinyl ester and the vinylalkoxysilane can be carried out by bulk, solution, suspension or emulsion polymerization techniques. Generally solution polymerization using a lower alcohol, preferably methanol, as a solvent is preferred. The bulk and solution polymerization process can be conducted either batchwise or continuously, while the suspension and emulsion polymerization processes are generally conducted batchwise. In batch processes it is known that the monomer composition can vary with the conversion depending upon the monomer reactivity ratios, r₁ and r₂. In order to obtain polymers having homogeneous comonomer compositions, therefore, it is necessary to add one or both of the monomers such that the monomer composition is maintained constant. This so called semi-batch process has been reported by R. J. Hanna in Industrial and Engineering Chemistry 49, 208-209 (1957) and T. Moritani and K. Kajitani in Polymer 38, 2933-2945 (1997). Similarly, in the case of continuous copolymerization in a plurality of columns, it is desirable to add one or more of the monomers to the second and subsequent columns so that the monomer composition in each column remains constant. The chemical scheme of typical copolymerization of vinyl acetate and vinyltrimethoxysilane is shown in FIG. 3-a.

Suitable examples of radical polymerization initiators which may be used includes 2,2′-azobis isobutyronitrile, benzoyl peroxide and acetyl peroxide. The polymerization temperature is generally selected within the range of 20° C. to the boiling point of the system. The conversion of each monomer is selected by considering factors such as economy, polymerization degree, as well as other factors. The amount of vinyltrialkoxysilane can be selected from the range of 0.01 to 1 mol % in resulting copolymer. The coating effects are not enough for the amount less than 0.01 mol %. The solubility of copolymer in water can decrease for the amount more than 1 mol %. The degree of polymerization of the copolymer can be adjusted in solution polymerization by controlling the amount of the solvent and the conversion rate. The preferred degree of polymerizations are 250 to 3000, more preferably 350 to 1000 considering the viscosity of aqueous solutions.

When part of vinyl ester remains unreacted in the reaction mixture after completion of the copolymerization, it should be removed by any suitable means, such as by distillation. The residual vinylalkoxysilane monomer need not always be removed since in many cases, it does not interface with subsequent treatments.

The vinyl ester units of the copolymer prepared in this manner are then hydrolyzed. The hydrolysis may advantageously be conducted in an alcoholic solution, preferably in a methanolic solution. The alcohol may either be absolute or contain a small amount of water or an appropriate amount of an organic solvent such as methyl acetate or ethyl acetate. As the catalyst for hydrolysis, alkaline catalysts such as an alkali methal hydroxide, e.g. sodium hydroxides, potassium hydroxide, alcoholate, e.g. sodium methylate, potassium methylate or ammonia; or acid catalysts such as hydrochloric acid or sulphuric acid can be used. Sodium hydroxide is preferred for economic reasons. Generally, the hydrolysis temperature is within the range of 10° to 60° C. The hydrolysis converts the vinyl ester units either partly or completely to vinyl alcohol units. The degree of conversion that is the degree of hydrolysis (DH), can have any suitable value depending on the properties required for coating. The degree of hydrolysis preferably amounts to 65 to 100 mol %. At hydrolysis reaction, a white gel or precipitate forms as the hydrolysis in the alcoholic medium proceeds. The gel or precipitate may be ground, washed and dried, giving a white polymer in powder form. The resultant product, poly(vinyl alcohol) modified with silanol group or PVAL-Si is water-soluble and dissolves in water or in an alkaline aqueous solution by heating. The chemical scheme of hydrolysis in case of the copolymer of vinyl acetate and vinyltrimethoxysilane is shown in FIG. 3-b, where methoxy groups in vinylmethoxysilane is all converted to sodium hydroxylate as well as all the vinyl acetate units are converted to vinyl alcohol units (DH=100 mol %) as a simple case of an example.

The preferred material for capillaries useful in the present invention is silica or glass. Fused silica capillaries have been utilized for decades in chromatography procedures and more recently have been used in electrophoresis procedures. Typical commercial products are supplied by Polymicro Technologies, LLC, Phoenix, Ariz. Internal diameters ranging from 25 to 100 μm are usually employed although capillary ranging 2 to 700 μm i.d. are available. They are coated outside with polyimide, fluoropolymer, acrylate or alminum for improving flexibility of the capillaries. The coating technology disclosed in this invention is not only limited to just common “capillaries” but also it can be applied to more advanced technology based on the principles similar to capillary electrophoresis. One of such examples is the planer chip-type substrate integrating channels inside, as shown by K. Seiler, D. J. Harrison and A. Manz, Anal. Chem., 65, 1481-1488 (1993). In this sense, capillaries described in this invention include such channels.

In the present invention, the inside of capillaries is coated with PVAL-Si. Usually as a preparation for coating, PVAL-Si is dissolved in pure water, at a concentration around 10 wt % for example by heating. It should be filtered with a filter, with 0.1 to 1.0 μm mesh size for example. A coating solution is prepared by mixing the concentrated aqueous solution of PVAL-Si, acid, such as hydrochloric acid and sulfuric acid, and pure water. The concentration of PVAL-Si in the coating solution is arbitrary and typically can be selected ranging from 0.1 to 8 wt %, more preferably 1 to 5 wt %. The concentration of the acid is also arbitrary and typically can be selected from the range of 0.05 to 3 N, more preferably 0.1 to 1 N.

A fused silica capillary is connected with a tool for injection, a syringe for example. As a preparative procedure, rinsing with an aqueous solution of NaOH followed by rinsing with pure water is preferable. The capillary is filled with the aqueous coating solution and kept stationary, for 2 to 40 hours for example, typically around 20 hours. The treated capillary is then rinsed with pure water until the outflow shows neutral pH and is stored by maintaining its ends with pure water.

In case of the copolymer of vinyl acetate and vinyltrimethoxsilane as a starting polymer, the chemical structures of the hydrolysed product can be shown by the general formula of Scheme III depending on the degree of conversion of methoxy groups in vinyltrimethoxysilane as well as the degree of hydrolysis of vinyl acetate units. Accordingly, PVAL-Si making covalent bonds with silanol groups on the surface of fused silica capillary can contain vinyl acetate units (Scheme IV).

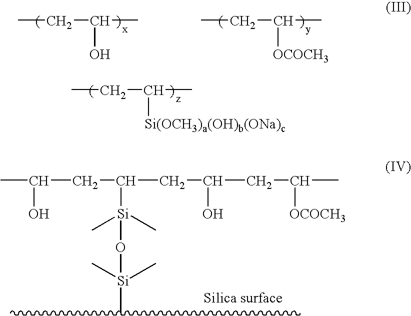

whrein z is molar fractions having the values preferably from 0.1 to 10 mol %, x is molar fractions having the values preferably from 70 to 99.99 mol %, and a, b and c are molar fractions having the values from 0 to 100 mol %. The degree of hydrolysis (DH), defined as 100×/(x+y), can be determined by the common analytical methods such as the titration method used for the analysis of common PVALs. The mole fraction of silanol is conveniently determined by using NMR for the copolymer before hydrolysis. The mole fractions, a, b and c, are changed depending on the conditions of aqueous solution for coating, mainly pH, and therefore do not need to be determined or specified.

The PVAL coating layer on silica surface thus formed using this invention can be used for further modifications by carrying out chemical reactions since the hydroxyl group in PVAL chains is know to be chemically reactive. By the reactions to the hydroxyl group, for example, other different polymer chains grafting to the PVAL chains may be formed as a new layer outside the PVAL layer.

In capillary electrophoresis, various polymers have also been used as media for sieving sample ions, DNA in particular. Typical polymers as media are poly(N,N-dimethylacrylamide) (PDMAM), poly(acrylamide) (PAM), agarose, hydroxyethyl cellulose (HEC), polyethylene glycol (PEG), poly(vinyl pyrrolidone) (PVP) and Pluronic polyols according to C. Heller [Electrophoresis 2001, 22, 629-643, “Principles of DNA separation with capillary electrophoresis”]. Recently, the present inventors have also discovered poly(vinyl alcohol)s or vinyl alcohol-based copolymers as separation media. The poly(vinyl alcohol) coated capillaries of this invention is more significantly effective when a poly(vinyl alcohol) or a vinyl alcohol-based copolymer is used as a separation medium, considering compatibility of the coating and medium polymers.

The coated capillaries of the present invention are easily and conveniently formed and adapted for use in any capillary electrophoresis system. Due to the much more economical procedure than the existing coated capillaries based on in-capillary polymerization, the reliable capillaries of the present invention can be supplied at more economical prices.

### EXEMPLIFICATION OF THE INVENTION

The invention now being generally described, it will be more readily understood by reference to the following examples, which are included merely for purposes of illustration of certain aspects and embodiment of the present invention, and are not intended to limit the invention.

### Example 1

### Synthesis of PVAL-Si

Chemicals used in on method for synthesizing PVAL-Si include vinyl acetate (VAc, stabilized), vinyltrimethoxysilane(VSi, 98%), and 2,2′-azobisisobutyronitrile (AIBN, 98%), from Aldrich Chemical Inc., Milwaukee, Wis. as well as methanol from Fisher Scientific Inc., VAc was distilled under a reduced pressure before use. The other chemicals were used as obtained.

Copolymerization of VAc and VSi was carried out using a 500 mL-glass reactor equipped with a stirrer, a thermometer, a reflux condenser and an inlet of nitrogen gas. Methanol was used as a solvent at the amount of 65% of the mixture. It works as a chain-transfer agent, and its amount can determine the degree of polymerization, 0.55×10³ for the present conditions. AIBN were used as an initiator. Three copolymers containing 0.05, 0.2 and 0.6 mol % of VSi units were synthesized using the mixtures of VAc/VSi/methanol/AIBN of 127/0.07/234/4, 127/0.3/234/4 and 127/0.9/230/4 g, respectively, placed in feed. The calculation based on the reactivity ratios reported in the literature, r₁=0.99 and r₂=0.01 where monomer 1=VAc and monomer 2=VSi, shows that the ratio of the two monomer units in the copolymer should be almost the same as the ratio of monomers in the feed at the range of the amounts less than 10 mol % for VSi units in copolymers. The reactor was deaerated with nitrogen gas and heated in a water bath. All the copolymerization processes were carried out in a homogeneous system at boiling temperatures of the mixture, 60° to 62° C. Copolymerization was finished by cooling the reactor and introducing air into it after the conversion of around 60% VAc. The residual VAc was distilled out under reduced pressure while adding methanol and then the methanol solution of poly(VAc-co-VSi) was obtained. It was converted to PVAL-Si by hydrolysis. The methanol solution of NaOH at the amount of 0.2 mole ratio to VAc units was added to the methanol solution of the poly(VAc-co-VSi) with stirring. A gelatinous material generated by hydrolysis was ground, washed with methanol and dried. The PVAL-Si (DH=100 mol % and 88 mol %) containing 0.05 and 0.2 mol % of silanol group showed good solubility in water, while the PVAL-Si (DH=100 mol %) containing 0.6 mol % of silanol group showed good solubility in alkaline aqueous solution. The degrees of polymerization were determined using a capillary viscometer as around 550.

### Example 2

### Coating Capillaries With PVAL-Si

The PVAL-Si (DH=100 mol %) containing 0.2 mol % of silanol group was dissolved in deionized water by heating to make 10 wt % of an aqueous solution. It was filtered with a Whatman Syrfil disposable syringe filter with 0.80 μm of mesh size. A fused silica capillary of 50 μm ID and 2 meter length was connected with a plastic syringe through a PEEK tube of 330 μm ID (Upchurch Scientific, Inc. WA), rinsed with 1 N NaOH for 1 h and followed by rinsing with deionized water. The capillary was filled with an aqueous solution containing 4 wt % of the PVAL-Si and 0.25 N of HCl and then kept stationary for 20 h. The treated capillary was rinsed with deionized water until the outflow showed neutral pH and was stored by maintaining its ends in two sample tubes filled with deionized water.

As a control experiment, the same procedure above was carried out using non-modified PVAL (MW=25,000, DS=98 mol % from Polyscience, Inc., Phonix, Ariz.), instead of PVAL-Si for coating.

### Example 3

### Measurements of EOF mobility

Bare fused silica capillaries, the capillaries coated inside with non-modified PVAL described above and the capillaries coated inside with the PVAL-Si (DH=100 mol %) containing 0.2 mol % of silanol group described above were used. A window of 2 mm width was opened at 10 cm from the anode end by stripping the polyimide coating off with a razor blade for a capillary with the total length of 13 cm. A 6 g/L methanol solution of a neutral dye sensitive to laser-induced fluorescence (LIF), coumarine 334, was injected at 3.9 kV for 5 s at the anodic end of the capillary and electrophoresis was carried out at 1.95 kV. EOF mobility was obtained from the retention time of the laser fluorescence peak observed.

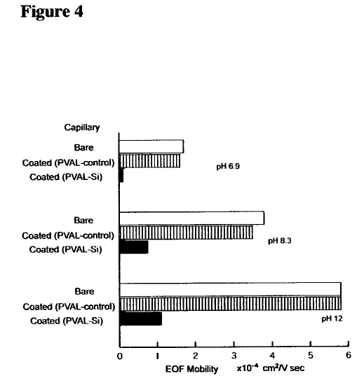

FIG. 4 shows the measurement results for the EOF mobility for three kinds of capillaries under three different pH conditions. The bare capillaries showed higher values of EOF mobility, 1.7, 3.8 and 5.8×10⁻⁴ cm³/V sec at 6.9, 8.3 and 12 of pH, respectively. Capillaries coated with a non-modified PVAL as a control has shown similar levels of mobility. Excellent decreases of EOF mobility were observed for the capillaries coated with PVAL-Si, <0.2, 0.8 and 1.1 cm³/V at 6.9, 8.3 and 12 of pH, respectively. Such small values of EOF mobility could be considered as another evidence for effective coating by the chemical reactions shown in FIG. 3-c.

### Example 4

### Capillary Electrophoresis

Chemicals used in on method for capillary electrophoresis include ethidium bromide (95%) from Aldrich Chemical Inc., Milwaukee, Wis., buffer solutions, 10×TTE (pH=8.3), 10× phosphate (pH=6.9) and 10×alkaline phosphate prepared from Tris, Taps, EDTA, sodium phosphate monobasic and sodium phosphate dibasic purchased from Sigma Inc., St. Louis, Mo., partially hydrolyzed poly(vinyl alcohol) (PVAL-AC) with MW=125,000 and the degree of hydrolysis (DH)=88 mol % from Polyscience, Inc., Phonix, Ariz. and double stranded (ds) DNA, pBR322 DNA HaeIII digest, from AB Gene, Rochester, N.Y.

Capillary electrophoresis experiments were performed with laboratory-made equipment that has a microscope laser-induced fluorescence detector and an incident Ar-ion laser beam operating at 488 nm. The capillaries, 78 μm i.d., coated inside with the PVAL-Si containing 0.2 mol % of silanol group described above were used. A window of 2 mm width was opened at 10 cm from the cathode end by stripping the polyimide coating off with a razor blade for a capillary with the total length of 13 cm. Both the cathode and anode reservoirs, 1.6 mL in volume, were filled with 1×TTE including ethidium bromide of 3 μg/mL. As a separation medium, a 1×TTE solution containing 5-wt % of PVAL-AC (MW=125,000, DS=88 mol %) was used. DNA, pBR322 HaeIII digest, was used at a concentration of 10 μg/mL. After filling the capillary with the separation medium, it was pre-run at 1.95 kV for 30 min. The DNA solution was electro-kinetically injected into the capillary at 0.65 kV for 3 s. Just after the DNA injection, electrophoretic run was performed at 1.95 kV and 25° C.

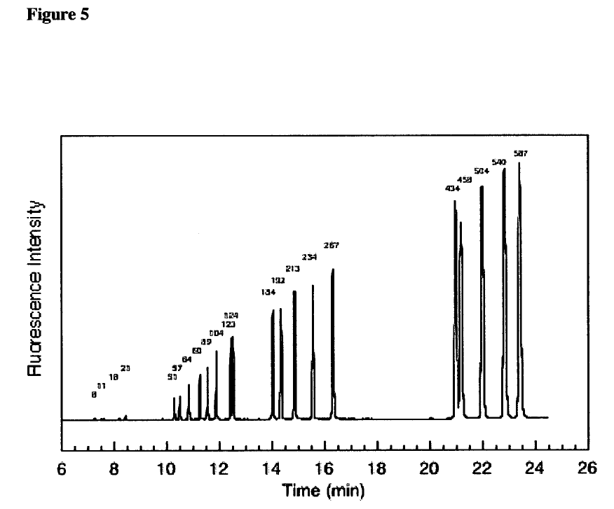

FIG. 5 shows a capillary electrophoresis spectrum for ds DNA using the coated capillary with the PVAL-Si (DH=100 mol %) and using PVAL (DS=2800, DH=88 mol %, concentration=5 wt %) as a medium. When using the capillary coated with PVAL-Si, 22 peaks are clearly resolved. Electrophoresis is significantly more stable and reproducible. The two peaks assigned to the base pairs with the difference of one base pair, 123 and 124, are resolved. The figure verifies the effectiveness for the new coating methods in this work.

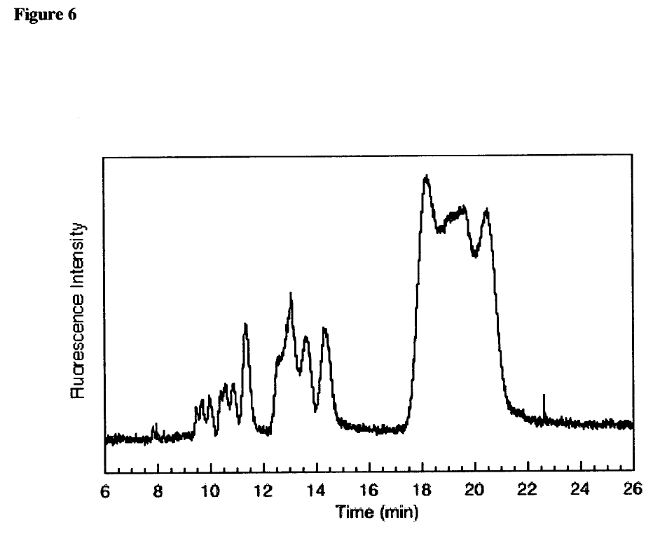

For comparison, similar capillary electrophoresis experiment has been carried out using bare capillaries. When using bare capillaries, electrophoresis was remarkably unstable. Quite often no peaks were observed. Similar situations were observed in capillaries treated with non-modified PVAL as a control. Even when peaks were observed as shown in FIG. 6, they were broad and not reproducible.

### Example 5

### Capillary Electrophoresis

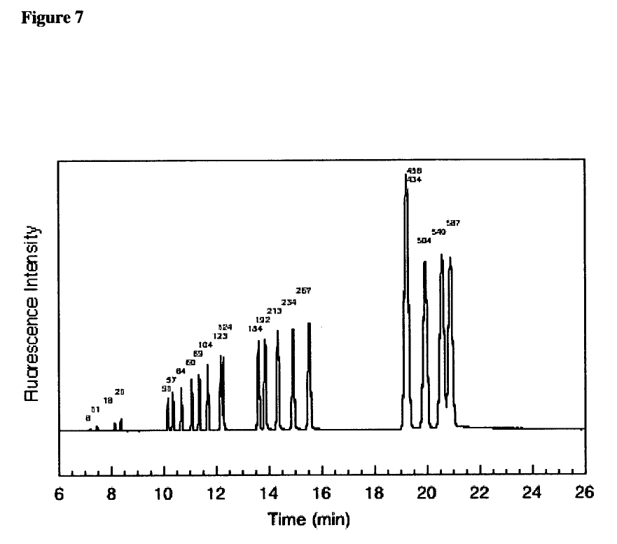

FIG. 7 shows a capillary electrophoresis spectrum for ds DNA using the coated capillary with the PVAL-Si (DH=100 mol %) containing 0.05 mol % of silanol group and using PVAL (DS=2800, DH=88 mol %, concentration=5 wt %) as a medium. Clearly resolved spectrum has also been obtained. Electrophoresis is significantly more stable and reproducible. The two peaks assigned to the base pairs with the difference of one base pair, 123 and 124, are resolved. The figure verifies the effectiveness for the new coating methods in this work.

### Example 6

### Capillary Electrophoresis

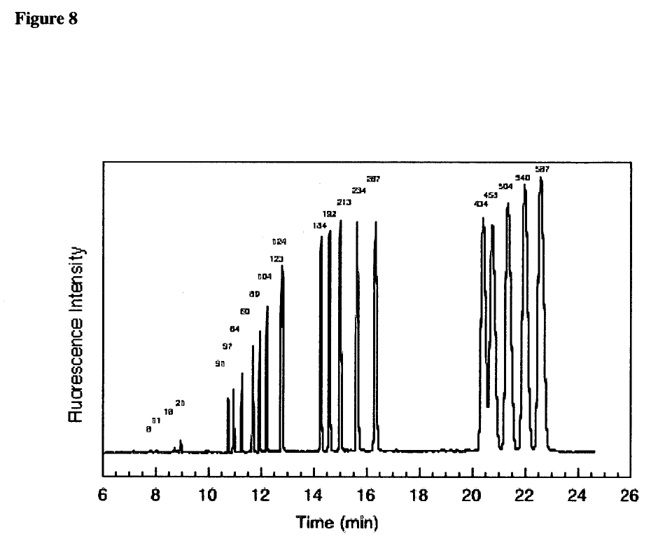

FIG. 8 shows a capillary electrophoresis spectrum for ds DNA using the coated capillary with the PVAL-Si (DH=88 mol %) containing 0.2 mol % of silanol group and using PVAL (DS=2800, DH=88 mol %, concentration=5 wt %) as a medium. Clearly resolved spectrum has also been obtained. Electrophoresis is significantly more stable and reproducible. The two peaks assigned to the base pairs with the difference of one base pair, 123 and 124, are resolved. The figure verifies the effectiveness for the new coating methods in this work.

### Example 7

### Capillary Electrophoresis

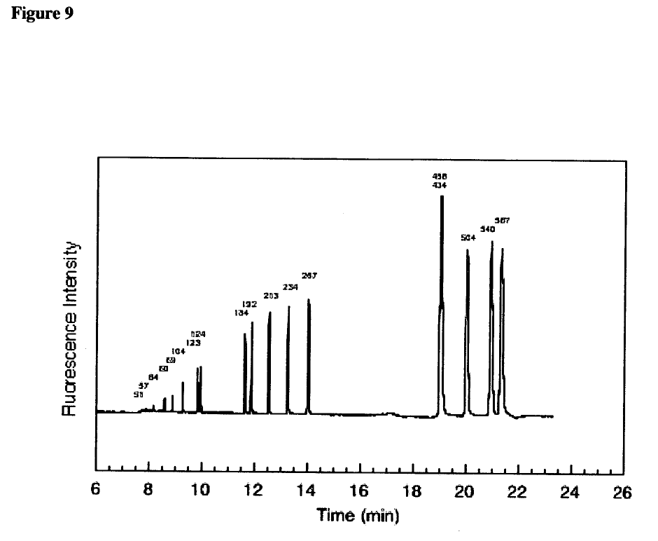

FIG. 9 shows a capillary electrophoresis spectrum for ds DNA using the coated capillary with the PVAL-Si (DH=100 mol %) containing 0.2 mol % of silanol group and using polyacrylamide (MW=9000, concentration=4 wt %) as a medium and. Clearly resolved spectrum has also been obtained. Electrophoresis is significantly more stable and reproducible. The figure verifies the effectiveness for the new coating methods in this work.

We claim:

1. A capillary, the inner surface of which is coated by the treatment of the copolymer comprising comonomer units represented by the formulae: 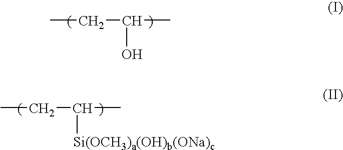
whrein R is a lower alkyl group, B is an alkali metal, and a, b and c are molar fractions having the values from 0 to 100 mol %.

2. The capillary of claim 1 is made of fused silica or glass.

3. The copolymer of claim 1, wherein in formula (II), R is methyl and B is sodium.

4. The copolymer of claim 1 is the hydrolysed product of poly(vinyl acetate-co-vinyltrialkooxysilane).

5. Poly(vinyl acetate-co-vinyltrialkoxysilane) of claim 4 is the copolymer comprising 0.01 to 1 mol % of vinyl trialkoxysilane comonomer units.

6. Poly(vinyl acetate-co-vinyltrialkoxysilane) of claims 4 is poly(vinyl acetate-co-vinyl trimethoxysilane) comprising 0.01 to 1 mol % of vinyl trimetoxysilane comonomer units.

7. The copolymer of claim 1, which comprises comonomer units respectively represented by the formulae: 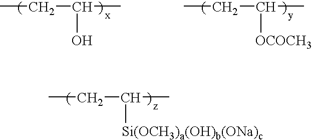
whrein z is molar fractions having the values from 0.01 to 1 mol %, x is molar fractions having the values from 70 to 99.99 mol %, and a, b and c are molar fractions having the values from 0 to 100 mol %.

8. The treatment of claim 1 comprises the use of an aqueous solution of the copolymer of claim 1 under acidic conditions.
